(19) United States
(12) Patent Application Publication
(10) Pub. No.: US 2006/0086396 A1
(43) Pub. Date: Apr. 27, 2006

(54) Electromagnetic hydraulic control valve

(75) Inventor: Motoyoshi Ando, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/255,864

(22) Filed: Oct. 24, 2005

(30) Foreign Application Priority Data
Oct. 25, 2004 (JP) 2004-309930

(51) Int. Cl. F15B 13/044

(52) U.S. Cl. 137/625.65

(57) ABSTRACT

In an electromagnetic hydraulic control valve for driving a spool type valve by means of an electromagnetic actuator, the electromagnetic actuator has a plunger and a core stator which slide on each other. Therefore their magnetic efficiency along their radial directions gets better and magnetic radial force generated at the plunger is suppressed to a constant level. Thus, increase of hysteresis in a high stroke range can be suppressed. In addition, magnetic radial force along the radial direction is stably generated even in a low stroke range, because of magnetic efficiency. This suppresses vibration of the plunger, and therefore an orifice used conventionally can be disused. By disusing the orifice, the influence of the viscosity of oil is reduced and a response of the spool at low temperature can be improved.

### CROSS REFERENCE TO RELATED APPLICATION

This application is based on and incorporates herein by reference Japanese patent application No. 2004-309930 filed on Oct. 25, 2004.

### FIELD OF THE INVENTION

The present invention relates to an electromagnetic hydraulic control valve controlling an oil pressure by means of a spool type valve and an electromagnetic actuator, and in particular to an electromagnetic hydraulic control valve incorporated into a hydraulic controller of an automatic transmission.

### BACKGROUND OF THE INVENTION

A conventional electromagnetic hydraulic control valve is shown in FIG. 4. The valve controls a hydraulic pressure by driving a spool type valve 1 by means of an electromagnetic actuator 2. The spool type valve 1 includes a sleeve 3, a spool 4, and a spring 5. The spool type valve 1 generates and adjusts an output pressure at an output port 8 by moving the spool 4 in the sleeve 3 along the axis of the electromagnetic hydraulic control valve and thus changing an input seal length (i.e. a lap A) and an bleed seal length (i.e. a lap B), wherein the input seal length is a length of a seal made by an input seal land 12 between an input port 7 and a division chamber 14 and the bleed seal length is a length of a seal made by an output seal land 13 between an bleed port 9 and the division chamber 14. The electromagnetic actuator 2 includes a coil 21, a plunger 22, and a fixed magnetic object 23 having a pulling stator 25 for pulling the plunger 22 along the axis. The electromagnetic actuator 2 drives the plunger 22 along the axis by changing an amount of an electric current to the coil 21 and thus moves the spool 4 along the axis by using a shaft 15 which is pressed to and fixed to the plunger 22.

The electromagnetic hydraulic control valve includes a means for avoiding change of the output pressure caused by the change of an input pressure at the input port 7. The avoiding means includes a feedback port (hereafter FB) on the sleeve 3, which is connected with the output port 8 through an outside of the sleeve 3, and an FB land J1, which is incorporated at a side of the spool 4 opposite to the spring 5 and has a smaller diameter than those of the input seal land 12 and the output seal land 13. The avoiding means supplies the output pressure to an FB chamber J2 between the input seal land 12 and the FB land J1.

An FB hydraulic pressure in the FB chamber J2 increases as the output pressure increases, because of the avoiding means. Then an axial force against a force from the spring 5 is generated because of a difference of pressing forces originated by the difference of the diameters of the input seal land 12 and the FB land J1. Therefore the output pressure is stabilized against external disturbances. Such an electromagnetic hydraulic control valve is described in, for example, JP-H10-122412-A.

However, such an electromagnetic hydraulic control valve tends to have the long the spool type valve 1, because of the FB chamber J2 and the FB land J1 for stabilizing the output pressure.

As shown in FIG. 4, the plunger 22 is supported by a bearing J3 and a plate spring J4, which make the plunger 22 slide along the axis smoothly, and a clearance is made between the plunger 22 and the fixed magnetic object 23 as described, for example, in JP-H10-122412-A.

Therefore, magnetic efficiency of the plunger 22 and the fixed magnetic object 23 along their radial direction gets worse in a sense that a magnetic force along the radial direction increases like a quadratic curve as stroke of the plunger 22 gets larger, as shown by a solid line F1 in FIG. 3A. As a result, hysteresis of the plunger 22 grows especially at a stroke range (hereafter high stroke range) near the end of a range in which the plunger 22 moves. Specifically, as shown in FIG. 3B, the hysteresis ΔPc of the output pressure grows at the high stroke range of the spool 4.

The plunger 22 tends to vibrate because it is supported by the bearing J3 and the plate spring J4, which make the plunger 22 slide, as described above.

In view of this, the conventional electromagnetic hydraulic control valve in JP-H10-122412-A suppresses the vibration of the spool 4 by forming in the sleeve 3 an FB orifice J5 connected with the FB chamber J2 or forming a dumper orifice J6 connected with a spring chamber containing the spring 5.

However, the suppression of the vibration of the spool 4 by means of the FB orifice J5 and the dumper orifice J6 is affected by viscosity of oil in the spool type valve 1. Therefore, the response of the spool 4 in low temperature gets slower as the viscosity grows in the low temperature.

Electromagnetic hydraulic control valves without the FB chamber J2 and the FB land J1 are described in JP-5-180318-A (corresponding to U.S. Pat. No. 5,277,399 and No. 5,217,047), and US Patent Publication No. 2002/0162593.

However, in the electromagnetic hydraulic control valve in JP-5-180318-A the response of the spool 4 at low temperature is slow, because the valve executes pilot pressure control by means of linear bleeding. In addition, the valve leaks a large amount of fluid.

In the electromagnetic hydraulic control valve described in US Patent Publication No. 2002/0162593 the response of the pressure 4 at low temperature is slow, because the valve suppresses the vibration of the spool 4 by forming the dumper orifice J6 connected with the spring chamber.

### SUMMARY OF THE INVENTION

It is therefore an object of the present invention to provide a new electromagnetic hydraulic control valve in which a spool type valve can be short.

In an electromagnetic hydraulic control valve of the invention for driving a spool type valve by means of an electromagnetic actuator, the spool type valve includes a sleeve, a spool, and a force biasing device for applying a force to the spool along an axis of the spool. The sleeve has an input port, an output port at which an output pressure is generated, and a bleed port. The spool has an input seal land for sealing the input port and an output seal land for sealing the bleed port, wherein the lands are located in the sleeve allowed to slide in the sleeve. In addition, the spool forms between the input seal land and the output seal land a division chamber connected with the output port.

Such a spool type valve changes, by moving the spool in the sleeve along the axis, an input seal length of a seal which is made by the input seal land and is between the input port and the division chamber and a bleed seal length of a seal which is made by the output seal land and is between the bleed port and the division chamber, so as to generate and adjust the output pressure.

In addition, the input seal land and the output seal land have different diameters and are pressed by the output pressure generated in the division chamber along the axis, and the input seal land and the output seal land are all lands the spool has.

Furthermore, the electromagnetic actuator includes a coil for generating a magnetic force, and a plunger allowed to slide along the axis for driving the spool along the axis, and a fixed magnetic object. The fixed magnetic object has a pulling stator and the magnetic stator. The pulling stator pulls the plunger along the axis by means of the generated magnetic force and the core stator surrounds the plunger and exchanges magnetic flux along its radial direction with the plunger. In addition, the electromagnetic actuator moves the spool along the axis against the force applied by the force biasing device by driving the plunger along the axis with changing the magnetic force generated at the core stator by changing the electric current to the coil.

Thus, in the spool type valve of the present invention, the input seal land and the output seal land have different diameter and are pressed by the output pressure generated in the division chamber, and the input seal land and the output seal land are all lands which the spool has. Therefore, the spool type valve does not have the FB chamber or the FB land which the above conventional electromagnetic hydraulic control valve has. Thus, the spool type valve can be short.

Besides, the plunger and the core stator may compose a magnetic circuit and may slide touching directly each other. Therefore, magnetic radial force is suppressed to a level (see a solid line F2 in FIG. 3A) because the magnetic efficiency of the fixed magnetic object 23 along their radial direction gets better and magnetic saturation occurs at a stroke. Thus, the hysteresis of the spool in the high stroke range can be suppressed and as a result increase of the hysteresis of the output pressure in the high stroke range can be suppressed.

In addition, magnetic radial force is generated stably (see the solid line F2 in FIG. 3A) even in a low stroke range, if the plunger and the core stator composing a magnetic circuit slide with touching directly each other. In this case, the plunger and a core stator slide sturdily at a wide stroke range starting from the low stroke range and the vibration of the plunger is suppressed. Since the sturdy sliding of the plunger in the wide stroke range suppresses the vibration of the plunger, the FB orifice and the dumper orifice used conventionally can be disused. By disusing the FB orifice and the dumper orifice, the effect of the viscosity of the oil is reduced and the response of the spool at a low temperature can be improved.

### BRIEF DESCRIPTION OF THE DRAWINGS

The invention, together with additional objective, features and advantages thereof, will be best understood from the following description, the appended claims and the accompanying drawings in which:

FIG. 1 is a cross section view of an electromagnetic hydraulic control valve according to an embodiment of the present invention along the axis thereof;

FIG. 2 is a cross section view for comparing physical sizes of the electromagnetic hydraulic control valves according to the embodiment and a conventional electromagnetic hydraulic control valve;

FIGS. 3A-C are graphs showing an operation of the electromagnetic hydraulic control valve; and

FIG. 4 is a cross section view of a conventional electromagnetic hydraulic control valve along its axis.

### DETAILED DESCRIPTION OF THE INVENTION

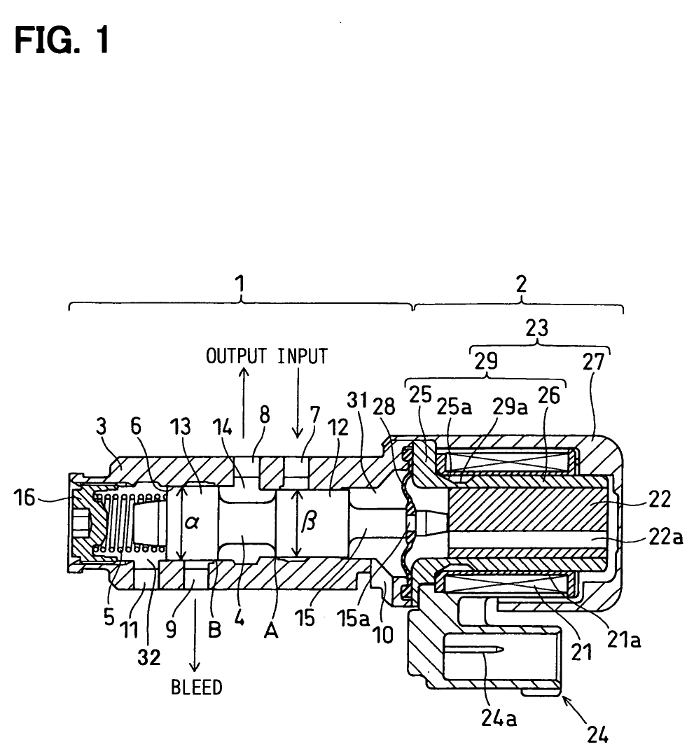

A first embodiment of the present invention will be described with reference to FIGS. 1-3. An electromagnetic hydraulic control valve according to the embodiment is incorporated into, for example, a hydraulic controller of an automatic transmission and includes a spool type valve 1 and an electromagnetic actuator 2 driving the spool type valve 1, as shown in FIG. 1.

(Description on the Spool Type Valve 1)

The spool type valve 1 includes a sleeve 3, a spool 4, and a spring 5 which corresponds to a force biasing means. The sleeve 3 is inserted into a case of a hydraulic controller (not illustrated) and is generally cylindrical. At the sleeve 3, a pushing through hole 6, an input port 7, an output port 8, and bleed port 9 are formed. The pushing through hole 6 supports the spool 4, allowing it to freely slide along the axis of the spool type valve 1. The input port 7 is connected with a discharge port of an oil pump (hydraulic pressure generation means; not illustrated) and an input pressure (e.g. 600 kPa) is supplied from the input port 7. The output port 8 outputs an output pressure adjusted at the electromagnetic hydraulic control valve. The bleed port 9 is connected with a low pressure side where oil is pooled.

The input port 7, the output port 8, and the bleed port 9 are holes, each formed at a lateral side of the sleeve 3. From the right side (the side to the electromagnetic actuator 2) to the left side (the side opposite to the electromagnetic actuator 2), a drain port 10 for respiration of a diaphragm chamber 31, the input port 7, the output port 8, the bleed port 9, and a drain port 11 for respiration of a spring chamber 32 are formed in this order.

The spool 4 is located in the sleeve 3 being allowed to slide in the sleeve 3, includes an input seal land 12 sealing the input port 7 and an output seal land 13 sealing the bleed port 9, and forms a division chamber 14 between the input seal land 12 and the output seal land 13. The division chamber 14 is connected with the output port 8. The spool 4 further includes a shaft 15 extending an interior of the electromagnetic actuator 2, the tip of which is in contact with an end surface of the plunger 22 so that the plunger 22 directly drives the spool 4.

When the spool type valve 1 with the structure described above moves the spool 4 along the axis under an operation of electromagnetic actuator 2, the ratio between an input seal length (i.e. a lap A) and an bleed seal length (i.e. a lap B) varies, wherein the input seal length is a length of a seal which is made by the input seal land 12 and is between the input port 7 and a division chamber 14, and the bleed seal length is a length of a seal which is made by an output seal land 13 and is between an bleed port 9 and the division chamber 14. As a result, the output pressure generated at the output port 8 varies.

The spring 5 is a compression coil spring which applies a force toward a valve-opening side, that is, the side where the input seal length is shortened and the output pressure increases (the right side in FIG. 1). The spring is compressed in the spring chamber 32 at the left of the sleeve 3. An end of the spring 5 is in contact with the left side surface of the spool 4, and the other end is in contact with a bottom surface of an adjustment screw 16 sealing the left end of the pushing through hole 6. The biasing force of the spring 5 can be adjusted by changing an amount of screwing-in of the adjustment screw 16.

(Characteristics of the Spool Type Valve 1)

The spool type valve 1 of the embodiment has characteristics as described below.

(1) A land diameter α of the output seal land 13 is larger than a land diameter β of the input seal land 12. When the pressure in the division chamber 14 (i.e. the output pressure) increases, an axial force to the spool 4 against the force from the spring 5 increases because of a growth in the difference between pressing forces to the input seal land 12 and to the output seal land 13, which originates from the difference of their diameters (hereafter land difference). Therefore the movement of the spool 4 is stabilized and this makes it possible to suppress the change of the output pressure caused by the change of the input pressure. The spool 4 comes to rest at a position where the biasing force of the spool 4 from the spring 5, the driving force to the spool 4 from the electromagnetic actuator 2, and the axial force originated from the land difference balance.

(2) All lands the spool 4 has are the input seal land 12 and the output seal land 13.

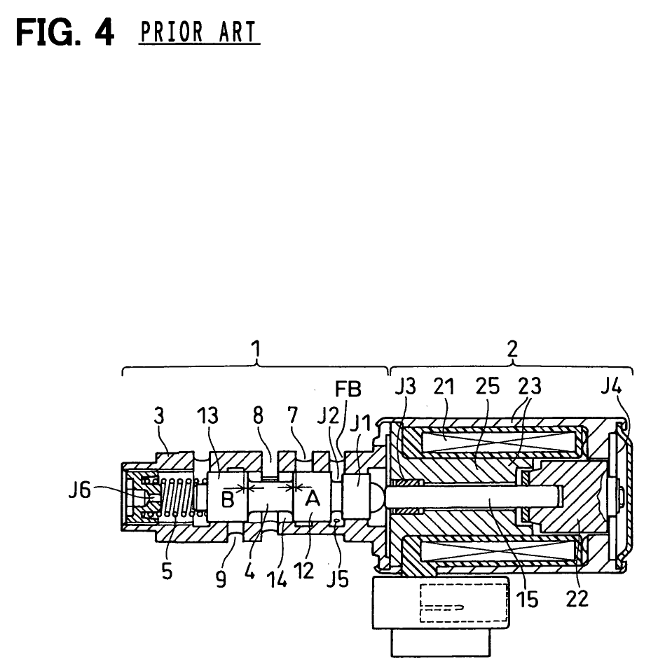

(3) The spool type valve 1 has neither the FB orifice J5 nor the damper orifice J6 shown in FIG. 4.

(Effect of the Spool Type Valve 1)

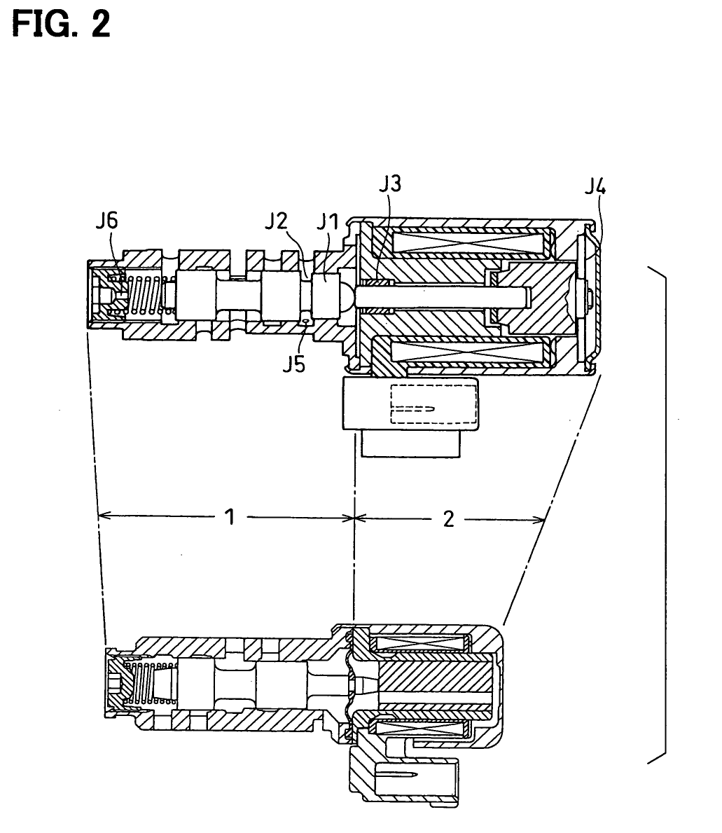

As shown above, in the electromagnetic hydraulic control valve, the land diameter α of the output seal land 13 is larger than the land diameter β of the input seal land 12, the output pressure generated in the division chamber 14 pushes the spool 4 along the axis, and no other land is not included. Specifically, the electromagnetic hydraulic control valve includes neither the FB chamber J2 or the FB land J1 shown in FIG. 4. Therefore, as shown in FIG. 2, the length of the spool type valve 1 can be designed to be shorter than the conventional electromagnetic hydraulic control valve.

(Description on the Electromagnetic Actuator 2)

The electromagnetic actuator 2 includes a coil 21, a plunger 22, a fixed magnetic object 23, and a connector 24. The coil 21 is made by coiling an enameled wire around a plastic bobbin predetermined times. The coil 21 generates a magnetic force and forms a loop of magnetic flux on receiving an electric current.

The plunger 22 is a magnetic metal (e.g. a ferromagnetic substance forming a magnetic circuit such as an iron) having generally cylindrical shape. The plunger 22 slides along the axis, touching the inner circumference of the fixed magnetic object 23 (specifically inner circumferences of a pulling stator 25 and a core stator 26 described later). As described above, the plunger 22 is directly in contact with the tip of the shaft 15, and receives a force from the spring 5 toward the valve-opening side along with the spool 4. In addition, the plunger 22 drives the spool 4 along the axis. A hole 22a penetrating the plunger 22 along the axis is a respiring hole connecting with the chambers at its both end.

The fixed magnetic object 23 includes the pulling stator 25, the core stator 26, and a yoke 27. The pulling stator 25 is a magnetic metal (e.g. a ferromagnetic substance forming a magnetic circuit such as an iron), which is sandwiched between the sleeve 3 and the coil 21 and pulls, by means of the magnetic force generated by the coil 21, the plunger 22 to a valve-closing side, that is, the side where the bleed seal length is shortened and the output pressure decreases (the left side in FIG. 1). In addition, the pulling stator 25 is magnetically coupled to the yoke 27. A magnetic pulling portion for pulling the plunger 22 along the axis is formed at an inner circumference of the pulling stator 25. An end of the plunger 22 can enter the inner circumference of the pulling stator 25, and the pulling stator 25 and a portion of the plunger 22 overlaps each other along the radial direction thereof. A taper 25a is formed at an outer surface of an inner cylindrical portion of the pulling stator 25 and adjusted so that the magnetic radial force of the pulling stator 25 is kept constant irrespective of the amount of the stroke of the plunger 22.

The core stator 26 is a magnetic metal (e.g. a ferromagnetic substance forming a magnetic circuit such as an iron) surrounding almost the whole circumference of the plunger 22 and having a generally cylindrical shape. In addition, the pulling stator 25 is magnetically coupled to the yoke 27. The core stator 26 exchanges magnetic flux along its radial direction with the plunger, and a magnetic flux receiving portion for executing the exchange of the magnetic flux between the plunger 22 and the core stator 26 is formed at an inner circumference of the core stator 26. The yoke 27 is a magnetic metal (e.g. a ferromagnetic substance forming a magnetic circuit such as an iron) which surrounds the coil 21 and flows the magnetic flux. The yoke 27 is firmly fixed to the sleeve 3 by caulking a craw portion at an end of the yoke 27.

The connector 24 is a connection means for providing an electrical connection with an electronic control unit (not illustrated) controlling the electromagnetic hydraulic control valve. Terminals 24a are located in the connector 24 and each of the terminals 24 is connected with each end of the coil 21. The electronic control unit controls an amount (hereafter current supply amount) of a current supplied to the coil 21. By controlling an supply amount of the current, the unit controls the output pressure generated at the output port 8, changing the ratio of the input seal length (lap A) and the bleed seal length (lap B) by linearly moving the position of the plunger 22 and the spool 4 along the axis.

(Characteristics of the Electromagnetic Actuator 2)

The electromagnetic actuator 2 of the embodiment has characteristics as described below.

(1) An end surface of the plunger 22 is directly in contact with the shaft 15 which extends to the interior of the electromagnetic actuator 2 and directly drives directly the spool 4.

(2) The plunger 22 and the core stator 26 which construct the magnetic circuit slide, touching each other.

(3) A diaphragm 28 is at a junction of the sleeve 3 and the electromagnetic actuator 2 and forms a border between the interior of the sleeve 3 and the interior of the electromagnetic actuator 2. The diaphragm 28 is made of rubber and has a generally ring-like shape. The outer rim of the diaphragm 28 is sandwiched by the sleeve 3 and the pulling stator 25 to prevent the oil in the sleeve 3 from leaking out to the outer circumference of the shaft 15. In addition, the central portion of the diaphragm 28 is engaged in a groove 15a formed on an outer surface of the shaft 15 to prevent the oil in the sleeve 3 from infiltrating into the interior of the electromagnetic actuator 2.

(4) The pulling stator 25 and the core stator 26 is constructed as a single stator component 29, and the stator component 29 is divided into the pulling stator 25 and the core stator 26 by a magnetoresistive unit 29a such as a thin-walled portion and a die cutting portion.

(5) The inner circumference of the stator component 29, on the inner circumference of which the plunger 22 slides, has a constant diameter which is slightly larger than the outer diameter of the plunger 22.

(Effect of the Electromagnetic Actuator 2)

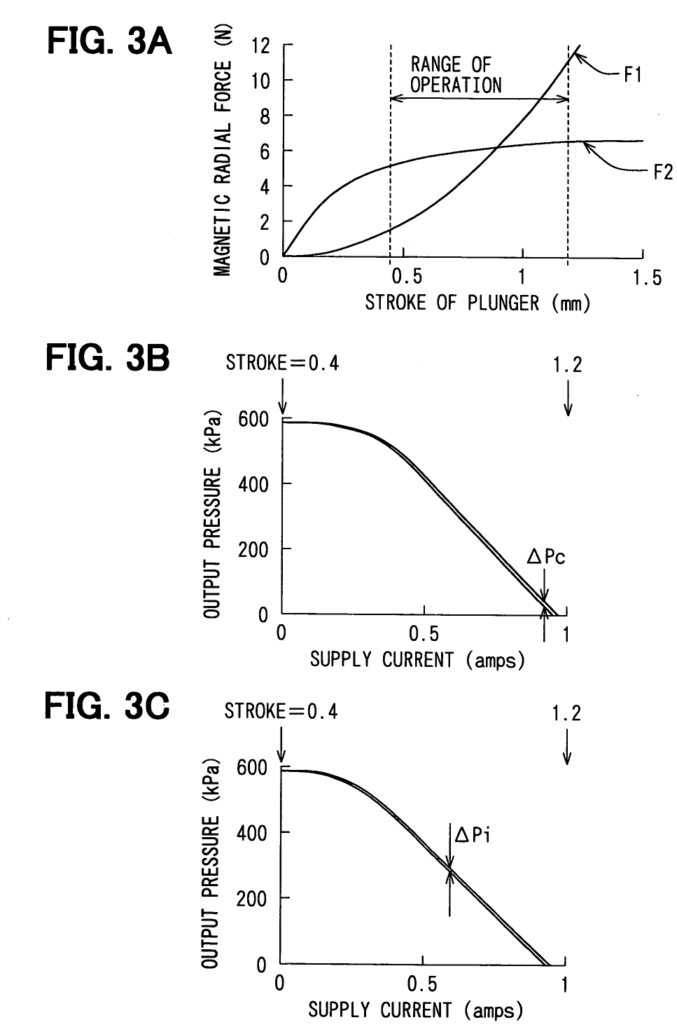

(1) In the electromagnetic actuator 2, magnetic efficiency of the plunger 22 and the core stator 26 along their radial directions increases, because the plunger 22 and the core stator 26 slide, touching each other. Therefore, as shown by the solid line F2 in FIG. 3A, even if the stroke of the plunger 22 increases, magnetic saturation occurs and the saturation suppress the magnetic radial force to the plunger 22 along the radial direction to a nearly constant level. Thus, the hysteresis of the plunger 22 in the high stroke range can be suppressed and as a result the hysteresis ΔPi of the output pressure in the high stroke range can be suppressed to a small value. Specifically, as shown in FIG. 3C, the hysteresis ΔPi can be constant through the whole stroke range of the spool 4. In the conventional art, the hysteresis ΔPi increases at the high stroke range.

(2) As shown in the solid line F2 in FIG. 3A, the magnetic radial force is stably generated even in a low stroke range, because the plunger 22 and the core stator 26 slide, touching directly each other. Thus, the plunger 22 and a core stator 26 slide sturdily at a wide stroke range starting from the low stroke range, and the vibration of the plunger 22 is suppressed. Since the sturdy sliding of the plunger in the wide stroke range suppresses the vibration of the plunger 22, the FB orifice J5 and the dumper orifice J6 in FIG. 4 used conventionally can be disused. By disusing the FB orifice J5 and the dumper orifice J6, the influence of the viscosity of the oil is reduced and the response of the spool at low temperature can be improved.

(3) The oil in the sleeve 3 does not infiltrate to around the plunger 22, because the interior of the electromagnetic actuator 2 is divided from the interior of the sleeve 3 by the diaphragm 28. Therefore, the plunger 22 is free from contamination of foreign bodies and thus the reliability of the electromagnetic hydraulic control valve is improved.

(4) The number of the components of the electromagnetic actuator 2 and the manufacturing cost thereof are reduced, because the pulling stator 25 and core stator 26 are constructed as a single stator component 29.

(5) There is no bump in the inner circumference of the fixed magnetic object 23, because the pulling stator 25 and the core stator 26 is constructed as a single stator component 29 and the inner circumference of the stator component 29, on which the plunger 22 slides on the inner circumference, has a constant diameter. Therefore, the plunger 22 can be easily incorporated into an electromagnetic solenoid (or a assembly for generating the magnetic flux made by incorporating the coil 21 to the fixed magnetic object 23).

(Effect of the Embodiment)

As shown above, the spool type valve 1 is short, the increase of the hysteresis in the high stroke range is suppressed, and the response of the spool 4 at low temperature can be quick.

(Modification)

The electromagnetic hydraulic control valve of the present invention may be used for any other device than the automatic transmission.

In addition, the oil ports such as the input port 7, the output port 8, and the bleed port 9 may be through holes formed at a longitudinal surface of the sleeve 3.

In addition, the spool 4 may move toward the electromagnetic actuator 2 as the current supply amount of the coil 21 increases.

Moreover, the spool 4 may move from the valve-closing side to the valve-opening side as the current supply amount of the coil 21 increases.

Furthermore, land diameter α of the output seal land 13 may be smaller than the land diameter β.

What is claimed is:

1. An electromagnetic hydraulic control valve for driving a spool type valve by means of an electromagnetic actuator, wherein
(a-1) the spool type valve includes:
a sleeve having:
an input port from which an input pressure is supplied;
an output port at which an output pressure is generated; and
a bleed port connected with a low pressure side;
a spool located in the sleeve and allowed to slide in the sleeve, the spool having:
an input seal land for sealing the input port; and
an output seal land for sealing the bleed port,
the spool forming, between the input seal land and the output seal land, a division chamber connected with the output port; and
a force biasing means for applying a force to the spool along an axis of the spool,
the spool type valve for changing, by moving the spool in the sleeve along the axis, an input seal length of a seal which is made by the input seal land and is between the input port and the division chamber and a bleed seal length of a seal which is made by the output seal land and is between the bleed port and the division chamber, so as to generate and adjust the output pressure;
the spool type valve generating and adjusting the output pressure by changing, with moving the spool in the sleeve along the axis, an input seal length of a seal which is made by the input seal land and is between the input port and the division chamber and a bleed seal length of a seal which is made by the output seal land and is between the bleed port and the division chamber;
(a-2) the input seal land and the output seal land have different diameters and are pressed along the axis by the output pressure generated in the division chamber;
(a-3) the input seal land and the output seal land are all lands which the spool has;
(a-4) the spool type valve includes neither a damper orifice nor feedback orifice;
(b-1) the electromagnetic actuator includes:
a coil for generating a magnetic force by receiving an electric current;
a plunger allowed to slide along the axis, for driving the spool along the axis; and
a fixed magnetic object having:
a pulling stator for pulling the plunger along the axis by means of the generated magnetic force; and
a core stator surrounding the plunger, for exchanging magnetic flux along a radial direction of the core stator with the plunger,
the electromagnetic actuator moving the spool along the axis against the force applied by the force biasing means by driving the plunger along the axis with changing the magnetic force generated at the core stator by changing the electric current to the coil;
(b-2) the plunger directly drives the spool; and
(b-3) the plunger and the core stator which compose a magnetic circuit slide, being directly in contact with each other.

2. The electromagnetic hydraulic control valve according to claim 1, further comprising a diaphragm installed at a juncture between the sleeve and the electromagnetic actuator, for forming a border between an interior of the sleeve and an interior of the electromagnetic actuator,

3. The electromagnetic hydraulic control valve according to claim 1, wherein the pulling stator and the core stator is made as a single component and the component is divided into the pulling stator and the core stator by a magnetoresistive unit at a middle of the component along an axis thereof.

4. The electromagnetic hydraulic control valve according to claim 3, wherein an inner diameter of the component is uniform and the plunger slides along an inner circumference of the component.

5. An electromagnetic hydraulic control valve for driving a spool type valve by means of an electromagnetic actuator, wherein
(a-1) the spool type valve includes:
a sleeve having:
an input port from which an input pressure is supplied;
an output port at which an output pressure is generated; and
a bleed port connected with a low pressure side;
a spool located in the sleeve and allowed to slide in the sleeve, the spool having:
an input seal land for sealing the input port; and
an output seal land for sealing the bleed port,
the spool forming, between the input seal land and the output seal land, a division chamber connected with the output port; and
a force biasing means for applying a force to the spool along an axis of the spool,
the spool type valve for changing, by moving the spool in the sleeve along the axis, an input seal length of a seal which is made by the input seal land and is between the input port and the division chamber and a bleed seal length of a seal which is made by the output seal land and is between the bleed port and the division chamber, so as to generate and adjust the output pressure;
(a-2) the input seal land and the output seal land have different diameters and are pressed along the axis by the output pressure generated in the division chamber;
(a-3) the input seal land and the output seal land are all lands which the spool has; and
(b-1) the electromagnetic actuator includes:
a coil for generating a magnetic force by receiving an electric current;
a plunger allowed to slide along the axis, for driving the spool along the axis; and
a fixed magnetic object having:
a pulling stator for pulling the plunger along the axis by means of the generated magnetic force; and
a core stator surrounding the plunger, for exchanging magnetic flux along a radial direction of the core stator with the plunger,
the electromagnetic actuator moving the spool along the axis against the force applied by the force biasing means by driving the plunger along the axis with changing the magnetic force generated at the core stator by changing the electric current to the coil.
